(19) United States
(12) Patent Application Publication
(10) Pub. No.: US 2004/0077769 A1
(43) Pub. Date: Apr. 22, 2004

(54) Polyamide molding compositions and electrical and electronic components molded therefrom having improved heat stability

(76) Inventors: Marvin M. Martens, Vienna, WV (US); Kate Redmond, Wilmington, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/637,782

(22) Filed: Aug. 8, 2003

Related U.S. Application Data
(60) Provisional application No. 60/402,355, filed on Aug. 9, 2002.

(51) Int. Cl. C08K 3/10; C08K 3/34; C08K 3/04; C08K 3/40

(52) U.S. Cl. 524/494; 524/495; 524/449; 524/409

(57) ABSTRACT

Polyamide molding compositions with improved blistering properties and electrical or electronic components made therefrom are provided. These compositions and components comprise 20-80 weight percent of polyamide or polyamide blend and comprising units derived from terephthalic acid or a derivative, and an aliphatic diamine with 10-20 carbons. Select ranges of inorganic filler and flame retardant and synergist are also disclosed.

### CROSS REFERENCE TO RELATED APPLICATIONS

This application claims the benefit of U.S. Provisional Application No. 60/402,355, filed Aug. 9, 2002.

### FIELD OF THE INVENTION

This invention relates to polyamide-based compositions having improved stability under soldering conditions. More particularly, this invention relates to electronic or electrical components made from such polyamide compositions that perform well under reflow oven soldering conditions and exhibit improved blistering properties, even after significant exposure to a hot, humid environment.

### BACKGROUND OF THE INVENTION

The recent significant progress that has been made in the electronics industry has been greatly abetted by the use of surface mount technology (SMT) to manufacture circuit boards. This technique involves applying a solder-containing paste to a printed circuit board, placing components on appropriate places on the surface of the board, and passing the entire assembly through an infrared reflow oven that serves to melt the solder and permanently affix the components to the board. Older, through-hole methods required that holes be drilled and that each component be individually soldered in place. SMT techniques have permitted the manufacture of smaller and denser layouts than were possible using through-hole techniques, and the resulting boards are generally cheaper to manufacture.

High reflow oven temperatures are required to melt the solder, and as traditional lead-containing solders are phased out and replaced with higher-melting lead-free alternatives, the processing temperatures required to manufacture many of these circuit boards will increase. Many of the components are based on polymeric materials that must be designed to withstand these elevated temperatures. Not only must such materials not melt or weaken under the processing temperatures, but they must also be resistant to the blistering that occurs on the surface of many plastic components when they are heated. This blistering is caused by the expansion of volatiles, often water, that are trapped in the part. Many materials that will perform well when kept very dry will blister when exposed to a significant amount of atmospheric moisture before soldering.

Because of their generally excellent physical properties, flame-retarded, reinforced high-melting polyamides such as those based on terephthalic acid, adipic acid, and hexamethylenediamine or terephthalic acid, hexamethylenediamine, and 2-methyl-1,5-pentanediamine that have melting points greater than about 280° C. would be suitable for components for SMT applications, but in many cases they absorb so much moisture when exposed to high-humidity conditions that they blister at temperatures that are too low to be practical.

It is therefore an object of the present invention to provide a polyamide molding composition which is suitable to withstand the severe constraints associated with the manufacture of electrical or electronic components. A feature of the present invention is its advantageous resistance to blistering. An advantage of the present invention is its applicability in the manufacture of a wide range of electrical and electronic components such as such as electronic connectors used in circuit boards. These and other objects, features and advantages of the instant invention will become better understood upon having reference to the following description of the invention.

### SUMMARY OF THE INVENTION

There is disclosed and claimed herein a polyamide molding composition having improved heat stability, comprising:

a polyamide molding composition having improved heat stability, comprising:

(a) 20 to 80 weight percent of a polyamide or polyamide blend having a melting point of greater than 280° C. comprising repeat units derived from,

(i) terephthalic acid or a derivative thereof and, optionally, one or more additional aromatic or aliphatic diacids or derivatives thereof and

(ii) one or more aliphatic diamines with 10 to 20 carbons, and optionally, one or more additional diamines,

(iii) and, optionally, one or more aminocarboxylic acids and/or lactams,

wherein terephthalic acid comprises 75 to 100 mole percent of (i), the one or more aliphatic diamines with 10 to 20 carbons comprise 75 to 100 mole percent of (ii), and the one or more aminocarboxylic acids or lactams comprise 0 to 25 mole percent of the total amount of (i)+(ii)+(iii);

(b) 5 to 60 weight percent of at least one inorganic filler or reinforcing agent;

(c) 5 to 35 weight percent of at least one flame retardant having 50-70 weight percent bromine or chlorine; and

(d) 1 to 10 weight percent of at least one flame retardant synergist.

The compositions of the present invention may optionally further comprise additives such as lubricants, antioxidants, heat stabilizers, impact modifiers, and processing aids. Articles made from these compositions are also disclosed and claimed herein, including components used in electrical and electronics applications, such as electronic connectors used in circuit boards. Connectors designed to be attached to circuit boards using SMT is one such example of a suitable application for the compositions herein.

### DETAILED DESCRIPTION OF THE INVENTION

The Polyamide

The polyamide of the present invention contains repeat units derived from terephthalic acid monomers and one or more aliphatic diamine monomers with 10 to 20 carbon atoms. The polyamide can optionally further include other repeat units derived from one or more additional saturated or aromatic dicarboxylic acid monomers and/or other aliphatic diamine monomers.

Suitable examples of additional dicarboxylic acid monomers include, but are not limited to, isophthalic acid, dodecanedioic acid, sebacic acid, and adipic acid. The terephthalic acid monomers will comprise about 75 to 100 mole percent, or preferably from about 80 to about 95 mole percent of the dicarboxylic acid monomers used to make the polyamide. As will be understood by those skilled in the art, the polyamide of this invention may be prepared from not only the dicarboxylic acids, but their corresponding carboxylic acid derivatives, which can include carboxylic acid esters, diesters, and acid chlorides.

The aliphatic diamine monomers may be linear or branched. Preferred aliphatic diamines are 1,10-diaminodecane and 1,12-diaminododecane. Additional aliphatic diamine monomers will preferably have fewer than 10 carbon atoms. Suitable examples include, but are not limited to, hexamethylenediamine and 2-methyl-1,5-pentanediamine. The one or more aliphatic diamines with 10 to 20 carbons will comprise about 75 to 100 mole percent, or preferably, about 80 to about 100 mole percent of the diamine monomers used to make the polyamide.

The polyamide can further optionally include repeat units derived from one or more aminocarboxylic acids (or acid derivatives) and/or lactams. Suitable examples include, but are not limited to, caprolactam, 11-aminoundecanoic acid, and laurolactam. If used, the one or more aminocarboxylic acids and lactams will preferably be present in from about 1 to about 25 mole percent of the total monomers used to make the polyamide.

Examples of suitable polyamides include, but are not limited to, one or more of polyamides derived from: terephthalic acid and 1,10-diaminodecane; terephthalic acid, isophthalic acid, and 1,10-diaminodecane; terephthalic acid, 1,10-diaminodecane, and 1,12-diaminododecane; terephthalic acid, dodecanedioic acid, and 1,10-diaminodecane; terephthalic acid, sebacic acid, and 1,10-diaminodecane; terephthalic acid, adipic acid, and 1,10-diaminodecane; terephthalic acid, dodecanedioic acid, 1,10-diaminodecane, and hexamethylenediamine; terephthalic acid, adipic acid, 1,10-diaminodecane, and hexamethylenediamine; terephthalic acid, 1,10-diaminodecane, and hexamethylenediamine; terephthalic acid, adipic acid, 1,10-diaminodecane, and dodecanedioic acid; terephthalic acid, 1,10-diaminodecane, and 11-aminoundecanoic acid; terephthalic acid, 1,10-diaminodecane, and laurolactam; terephthalic acid, 1,10-diaminodecane, and caprolactam; terephthalic acid, 1,10-diaminodecane, and 2-methyl-1,5-petanediamine; terephthalic acid, adipic acid, 1,10-diaminodecane, and 2-methyl-1,5-petanediamine; terephthalic acid and 1,12-diaminododecane; terephthalic acid, isophthalic acid, and 1,12-diaminododecane; terephthalic acid, dodecanedioic acid, and 1,12-diaminododecane; terephthalic acid, sebacic acid, and 1,12-diaminododecane; terephthalic acid, adipic acid, and 1,12-diaminododecane; terephthalic acid, dodecanedioic acid, 1,12-diaminododecane, and hexamethylenediamine; terephthalic acid, adipic acid, 1,12-diaminododecane, and hexamethylenediamine; terephthalic acid, adipic acid, and 1,12-diaminododecane; hexamethylenediamine; terephthalic acid, adipic acid, 1,12-diaminododecane, and dodecanedioic acid; terephthalic acid, 1,12-diaminododecane, and 11-aminoundecanoic acid; terephthalic acid, 1,12-diaminododecane, and laurolactam; terephthalic acid, 1,12-diaminododecane, and caprolactam; terephthalic acid, 1,12-diaminododecane, and 2-methyl-1,5-petanediamine; and terephthalic acid, adipic acid, 1,12-diaminododecane, and 2-methyl-1,5-petanediamine.

Blends of two or more polyamides may be used in the present invention. The polyamides used in the present invention will preferably have melting points of 280-340° C.

There are no particular limitations on the process used to produce the polyamide of the present invention. It may be produced by ordinary melt polymerization, such as in a one-step autoclave process. It may also be produced in a process that includes preparing a prepolymer that that is subjected to solid-phase polymerization or melt-mixing in an extruder to increase its molecular weight. See generally U.S. Pat. No. 6,350,802, which is incorporated by reference herein.

The Flame Retardant and Synergist

The composition of the present invention contains 5 to 35 weight percent of a bromine or chlorine-containing flame retardant. Examples of suitable flame retardants include, but are not limited to, brominated polystyrenes and polystyrene copolymers, poly(dibromostyrene) and copolymers of dibromostyrene. The flame retardant will contain about 50 to 70 weight percent halogen.

The halogen-containing flame retardant is used in conjunction with about 1 to 10 weight percent of an auxiliary flame retardant synergist such as antimony trioxide, antimony pentoxide, sodium antimonate, zinc borate, and the like.

The Inorganic Filler

The composition of the present invention contains 10 to 60 weight percent of an inorganic filler or reinforcing agent that includes, for example, fibrous reinforcement such as glass fiber and carbon fiber, glass beads, talc, kaolin, wollastonite, and mica. Preferable among them is glass fiber. Glass fibers suitable for use in the present invention are those generally used as a reinforcing agent for thermoplastic resins and thermosetting resins. Preferred glass fiber is in the form of glass rovings, glass chopped strands, and glass yarn made of continuous glass filaments 3 to 20 μm in diameter.

Additional Ingredients

The composition of the present invention may optionally contain additional ingredients that can include, but are not limited to heat stabilizers, processing aids, lubricants, mold-release agents, color additives, impact modifiers, and antioxidants. These may be added in effective amounts, and so as not to deleteriously affect the overall blistering resistant properties of the composition, as will be appreciated to those having skill in the art to which the invention pertains.

Processing

The ingredients are combined and melt-blended, using any reasonable melt-processing method, such as extrusion, and the resulting composition is formed into the components of the present invention using a melt-processing method such as injection molding. It will be readily appreciated that the melt-processing and molding techniques useful herein may be selected from any of a variety of well-known and conventional sources.

Electrical and electronic components may be made from the compositions of the present invention. These will preferably be standard electronic connectors connected to electronic circuit boards such as motherboards and auxiliary boards. Examples of electronic connectors include single inline memory modules, dual inline memory modules, and modular jacks. The connectors will preferably further comprise conductive pins. The connectors may be used in any electronic device such as computers, televisions, radios, VCRs, telephones, other consumer electronic devices and appliances, vehicles, industrial devices, instruments, or other device that incorporates electronic circuit boards.

The connectors will preferably be affixed to circuit boards using surface mount technology, preferably using a lead-free solder. The connectors formed from the composition of the present invention will preferably not form surface blisters when the connector is passed through a commercial infrared reflow soldering oven with a peak temperature of 255° C. for about 300 seconds, after having been conditioned at 40° C. and 95 percent relative humidity for 168 hours. The connectors will more preferably not form surface blisters when the reflow oven has a peak temperature of 260° C.

### EXAMPLES

### Example 1

A 10 L autoclave was charged with terephthalic acid (1040.48 g), dodecanedioic acid (160.27 g), 1,10-diaminodecane (1236.33 g), an aqueous solution containing 0.5 weight percent sodium hypophosphite and 2.5 weight percent sodium bicarbonate (42.99 g), an aqueous solution containing 28 weight percent acetic acid (29.34 g), an aqueous solution containing 1 weight percent Carbowax® 8000 (4.30 g) and water (3562.91 g). The autoclave agitator was set to 5 rpm and the contents were purged with nitrogen at 10 psi for 10 minutes. The agitator was set to 50 rpm, the pressure relief valve was set to 250 psig, and the autoclave was heated to 225° C. The pressure reached 250 psig after about 60 minutes and was held there for another about 40 minutes until the temperature of the autoclave contents had reached 225° C. The temperature relief value was then set at 350 psig. The pressure rose to 350 psig over about 15 minutes, where it was held for about 85 minutes. During this time, the temperature of the autoclave contents rose to about 295° C. The pressure was then reduced to 0 psig over about 45 minutes. During this time, the temperature of the autoclave contents rose to 320° C. The autoclave was pressurized with about 50 psig nitrogen and the molten polymer was cast from the autoclave. The collected polymer was cooled with steam and water and cut.

### Example 2 and Comparative Example 1

The ingredients used in Example 2 and Comparative Example 1 and shown in Table 1 were compounded in a ZSK-40 Werner & Pfleiderer twin-screw extruder operating at 90 pounds per hour and 270-280 RPM. The melt temperature was 338° C. for Example 2 and 329° C. for Comparative Example 1. Upon exiting the extruder, the polymer was passed through a die to make strands, which were frozen in a quench tank and subsequently chopped to make pellets. Glass fibers were side-fed and the other ingredients were rear-fed, except for the Licowax OP, which was surface coated on the pellets.

Flame retardance testing was done according to UL Test No. UL-94 (20 mm Vertical Burning Test) 1/32^{th} inch (referred to in Table 1 as 0.8 mm) thick test pieces. The test pieces were conditioned for either 48 hours at 23° C. and 50% relative humidity or 168 hours at 70° C. prior to flammability testing. The results are referred to in Table 1 as “Flame retardance 23° C./48 hr” and “Flame retardance 70° C./168 hr”, respectively.

Blistering performance was measured on parts made by molding the compositions in Table 1 into 37×8×3 mm multi-hole pin connectors and 0.8 mm thick flexural bars. The parts were molded using a 335° C. melt temperature and either a 80° C. or a 120° C. mold temperature. The parts were conditioned at 40° C. and 95% relative humidity for 168 hours. The moisture content of the bars was measured after conditioning and the results are given in Table 1 and then passed through an infrared reflow soldering oven. The residence time in the oven was about 300 seconds. The temperature experienced by the bars ramped up to the peak temperature over the first about 190-220 seconds, remained at the peak temperature for about 2 to 3 seconds, and then cooled for the remainder of the time in the oven. The bars were passed through the oven several times. Each time, the peak temperature of the oven was increased in 5° C. increments. The highest temperature at which no blisters were formed on the part's surface are formed during passage through the oven is the “peak reflow oven temperature” given in Table 1.

In Table 1:

6,T/6,6 refers to a 65 mole percent hexamethylenediamine-terephthalic acid/45 mole percent hexamethylenediamine-adipic acid copolymer.

10,T/10,12 refers to a 90 mole percent 1,10-diaminodecane-terephthalic acid/10 mole percent 1,10-diaminodecane-dodecanedioic acid copolymer prepared as described in Example 1.

Firebrake® ZB refers to zinc borate hydrate manufactured by U.S. Borax, Valencia, Calif.

Himilan® 1707 refers to a neutralized ethylene-methacrylic acid copolymer manufactured by Du Pont-Mitsui Polychemicals Co., Ltd., Tokyo, Japan.

PED 521 refers to Licowax PED 521 manufactured by Clariant Corp., Charlotte, N.C.

PDBS-80 refers to poly(bromostyrene) containing 59 weight percent bromine manufactured by Great Lakes Chemical Corp., West Lafayette, Ind.

Glass fibers refers to FT756X manufactured by Asahi Glass, Tokyo, Japan.

Licowax® OP refers to a lubricant manufactured by Clariant Corp., Charlotte, N.C.

TABLE 1

| | | Comparative |
|---|---|---|
| | Example 2 | Example 1 |
| 6, T/6, 6 | — | 40.5 |
| 10, T/10, 12 | 38.85 | — |
| Sodium antimonate | 4 | 4 |
| Firebrake ® ZB | 0.3 | 0.3 |
| Himilan ® 1707 | 1 | 1 |
| PED 521 | 0.2 | 0.2 |
| PDBS-80 | 25.65 | 24 |
| Glass fibers | 30 | 30 |
| Licowax ® OP | 0.10 | 0.10 |
| Melting point (° C.) | 300 | 312 |
| Flame retardance 23° C./48 hr | V-0 | V-0 |
| Flame retardance 70° C./168 hr | V-0 | V-0 |
| Multi-hole pin connectors; 80° C. mold | | |
| Peak reflow oven temperature (° C.) | 260 | 245 |
| Moisture content after conditioning | 1.2 | 2.5 |
| (weight percent) | | |
| Multi-hole pin connectors; 120° C. mold | | |
| Peak reflow oven temperature (° C.) | 265 | 255 |
| Moisture content after conditioning | 1.0 | 2.4 |
| (weight percent) | | |
| 0.8 mm flexural bar; 80° C. mold | | |
| Peak reflow oven temperature (° C.) | 255 | 245 |
| Moisture content after conditioning | 1.2 | 2.6 |
| (weight percent) | | |
| 0.8 mm flexural bar; 120° C. mold (° C.) | | |
| Peak reflow oven temperature (° C.) | 255 | 245 |
| Moisture content after conditioning | 1.0 | 2.5 |
| (weight percent) | | |

All ingredients quantities are given in weight percent relative to the total weight of the composition.

In the claims:

1. A polyamide molding composition having improved heat stability, comprising:
(a) 20 to 80 weight percent of a polyamide or polyamide blend having a melting point of greater than 280° C. comprising repeat units derived from,
(i) terephthalic acid or a derivative thereof and, optionally, one or more additional aromatic or aliphatic diacids or derivatives thereof and
(ii) one or more aliphatic diamines with 10 to 20 carbons, and optionally, one or more additional diamines,
(iii) and, optionally, one or more aminocarboxylic acids and/or lactams,
wherein terephthalic acid comprises 75 to 100 mole percent of (i), the one or more aliphatic diamines with 10 to 20 carbons comprise 75 to 100 mole percent of (ii), and the one or more aminocarboxylic acids or lactams comprise 0 to 25 mole percent of the total amount of (i)+(ii)+(iii);
(b) 5 to 60 weight percent of at least one inorganic filler or reinforcing agent;
(c) 5 to 35 weight percent of at least one flame retardant having 50-70 weight percent bromine or chlorine; and
(d) 1 to 10 weight percent of at least one flame retardant synergist.

2. The composition of claim 1 where the aliphatic diamine is one or more of 1,10-diaminodecane or 1,12-diaminododecane.

3. The composition of claim 1 wherein the inorganic filler or reinforcing agent (b) is selected from the group consisting of one or more of glass fiber, carbon fiber, glass beads, talc, kaolin, wollastonite, and mica.

4. The composition of claim 1 wherein the flame retardant (c) is selected from the group consisting of one or more of brominated polystyrenes and polystyrene copolymers, poly(dibromostyrene), and copolymers of dibromostyrene.

5. The composition of claim 1 wherein the flame retardant synergist (d) is selected from the group consisting of one or more of antimony trioxide, antimony pentoxide, sodium antimonate, and zinc borate.

6. The composition of claim 1 wherein the polyamide is one or more of polyamides derived from: terephthalic acid and 1,10-diaminodecane; terephthalic acid, isophthalic acid, and 1,10-diaminodecane; terephthalic acid, 1,10-diaminodecane, and 1,12-diaminododecane; terephthalic acid, dodecanedioic acid, and 1,10-diaminodecane; terephthalic acid, sebacic acid, and 1,10-diaminodecane; terephthalic acid, adipic acid, and 1,10-diaminodecane; terephthalic acid, dodecanedioic acid, 1,10-diaminodecane, and hexamethylenediamine; terephthalic acid, adipic acid, 1,10-diaminodecane, and hexamethylenediamine; terephthalic acid, 1,10-diaminodecane, and hexamethylenediamine; terephthalic acid, adipic acid, 1,10-diaminodecane, and dodecanedioic acid; terephthalic acid, 1,10-diaminodecane, and 11-aminoundecanoic acid; terephthalic acid, 1,10-diaminodecane, and laurolactam; terephthalic acid, 1,10-diaminodecane, and caprolactam; terephthalic acid, 1,10-diaminodecane, and 2-methyl-1,5-petanediamine; terephthalic acid, adipic acid, 1,10-diaminodecane, and 2-methyl-1,5-petanediamine; terephthalic acid and 1,12-diaminododecane; terephthalic acid, isophthalic acid, and 1,12-diaminododecane; terephthalic acid, dodecanedioic acid, and 1,12-diaminododecane; terephthalic acid, sebacic acid, and 1,12-diaminododecane; terephthalic acid, adipic acid, and 1,12-diaminododecane; terephthalic acid, dodecanedioic acid, 1,12-diaminododecane, and hexamethylenediamine; terephthalic acid, adipic acid, 1,12-diaminododecane, and hexamethylenediamine; terephthalic acid, adipic acid, and 1,12-diaminododecane; hexamethylenediamine; terephthalic acid, adipic acid, 1,12-diaminododecane, and dodecanedioic acid; terephthalic acid, 1,12-diaminododecane, and 11-aminoundecanoic acid; terephthalic acid, 1,12-diaminododecane, and laurolactam; terephthalic acid, 1,12-diaminododecane, and caprolactam; terephthalic acid, 1,12-diaminododecane, and 2-methyl-1,5-petanediamine; and terephthalic acid, adipic acid, 1,12-diaminododecane, and 2-methyl-1,5-petanediamine.

7. An electronic connector comprising the compositions of any of claims 1-6.

8. An electrical or electronic component comprising a polyamide molding composition having improved heat stability, comprising:
(a) 20 to 80 weight percent of a polyamide or polyamide blend having a melting point of greater than 280° C. comprising repeat units derived from,
(i) terephthalic acid or a derivative thereof and, optionally, one or more additional aromatic or aliphatic diacids or derivatives thereof and
(ii) one or more aliphatic diamines with 10 to 20 carbons, and optionally, one or more additional diamines,
(iii) and, optionally, one or more aminocarboxylic acids and/or lactams,
wherein terephthalic acid comprises 75 to 100 mole percent of (i), the one or more aliphatic diamines with 10 to 20 carbons comprise 75 to 100 mole percent of (ii), and the one or more aminocarboxylic acids or lactams comprise 0 to 25 mole percent of the total amount of (i)+(ii)+(iii);
(b) 5 to 60 weight percent of at least one inorganic filler or reinforcing agent;
(c) 5 to 35 weight percent of at least one flame retardant having 50-70 weight percent bromine or chlorine; and
(d) 1 to 10 weight percent of at least one flame retardant synergist.

9. The electrical or electronic component of claim 8 where the aliphatic diamine is one or more of 1,10-diaminodecane or 1,12-diaminododecane.

10. The electrical or electronic component of claim 8 wherein the inorganic filler or reinforcing agent (b) is selected from the group consisting of one or more of glass fiber, carbon fiber, glass beads, talc, kaolin, wollastonite, and mica.

11. The electrical or electronic component of claim 8 wherein the flame retardant (c) is selected from the group consisting of one or more of brominated polystyrenes and polystyrene copolymers, poly(dibromostyrene), and copolymers of dibromostyrene.

12. The electrical or electronic component of claim 8 wherein the flame retardant synergist (d) is selected from the group consisting of one or more of antimony trioxide, antimony pentoxide, sodium antimonate, and zinc borate.

13. The electrical or electronic component of claim 8 wherein the polyamide is one or more of polyamides derived from: terephthalic acid and 1,10-diaminodecane; terephthalic acid, isophthalic acid, and 1,10-diaminodecane; terephthalic acid, 1,10-diaminodecane, and 1,12-diaminododecane; terephthalic acid, dodecanedioic acid, and 1,10-diaminodecane; terephthalic acid, sebacic acid, and 1,10-diaminodecane; terephthalic acid, adipic acid, and 1,10-diaminodecane; terephthalic acid, dodecanedioic acid, 1,10-diaminodecane, and hexamethylenediamine; terephthalic acid, adipic acid, 1,10-diaminodecane, and hexamethylenediamine; terephthalic acid, 1,10-diaminodecane, and hexamethylenediamine; terephthalic acid, adipic acid, 1,10-diaminodecane, and dodecanedioic acid; terephthalic acid, 1,10-diaminodecane, and 11-aminoundecanoic acid; terephthalic acid, 1,10-diaminodecane, and laurolactam; terephthalic acid, 1,10-diaminodecane, and caprolactam; terephthalic acid, 1,10-diaminodecane, and 2-methyl-1,5-petanediamine; terephthalic acid, adipic acid, 1,10-diaminodecane, and 2-methyl-1,5-petanediamine; terephthalic acid and 1,12-diaminododecane; terephthalic acid, isophthalic acid, and 1,12-diaminododecane; terephthalic acid, dodecanedioic acid, and 1,12-diaminododecane; terephthalic acid, sebacic acid, and 1,12-diaminododecane; terephthalic acid, adipic acid, and 1,12-diaminododecane; terephthalic acid, dodecanedioic acid, 1,12-diaminododecane, and hexamethylenediamine; terephthalic acid, adipic acid, 1,12-diaminododecane, and hexamethylenediamine; terephthalic acid, adipic acid, and 1,12-diaminododecane; hexamethylenediamine; terephthalic acid, adipic acid, 1,12-diaminododecane, and dodecanedioic acid; terephthalic acid, 1,12-diaminododecane, and 11-aminoundecanoic acid; terephthalic acid, 1,12-diaminododecane, and laurolactam; terephthalic acid, 1,12-diaminododecane, and caprolactam; terephthalic acid, 1,12-diaminododecane, and 2-methyl-1,5-petanediamine; and terephthalic acid, adipic acid, 1,12-diaminododecane, and 2-methyl-1,5-petanediamine.

14. The electrical or electronic component of any of claims 8-13 in the form of an electronic connector used in circuit boards.
